(19) United States
(12) Patent Application Publication
(10) Pub. No.: US 2015/0030906 A1
(43) Pub. Date: Jan. 29, 2015

(54) AQUEOUS POLYVINYLIDENE FLUORIDE COMPOSITION

(71) Applicant: Arkema Inc., King of Prussia, PA (US)

(72) Inventors: Ramin Amin-Sanayei, Malvern, PA (US); Scott R. Gaboury, Blue Bell, PA (US)

(21) Appl. No.: 14/379,540

(22) PCT Filed: Feb. 21, 2013
(86) PCT No.: PCT/US13/26996

§ 371 Date: Aug. 19, 2014

Related U.S. Application Data
(60) Provisional application No. 61/601,278, filed on Feb. 21, 2012.

(51) Int. Cl. H01M 2/16; H01G 11/52

(52) U.S. Cl. CPC H01M 2/1686; H01G 11/52
USPC 429/144; 361/502

(57) ABSTRACT

The invention relates to a separator for non-aqueous-type electrochemical device that has been coated with an aqueous fluoropolymer coating. The fluoropolymer is preferably polyvinylidene fluoride (PVDF), and more preferably a copolymer of polyvinylidene fluoride. The fluoropolymer coating provides a porous coating on porous substrate separator used in non-aqueous-type electrochemical devices, such as batteries and electric double layer capacitors. The fluoropolymer coating improves the thermal resistance and mechanical integrity, and lowers the interfacial electrical impedance of the porous separator. The fluoropolymer composition optionally contains powdery particles that are held together on the separator by the fluoropolymer binder. In one embodiment, the starting fluoropolymer dispersion is free of fluorinated surfactant. In another embodiment, one or more fugitive adhesion promoters are added.

### FIELD OF THE INVENTION

The invention relates to a separator for non-aqueous-type electrochemical device that has been coated with an aqueous fluoropolymer coating. The fluoropolymer is preferably polyvinylidene fluoride (PVDF), and more preferably a copolymer of polyvinylidene fluoride. The fluoropolymer coating provides a porous coating on porous substrate used in non-aqueous-type electrochemical devices, such as batteries and electric double layer capacitors. The fluoropolymer coating improves the thermal resistance and mechanical integrity, and lowers the interfacial electrical impedance of the porous separator. In one embodiment, porous separator is coated with an aqueous fluoropolymer-based composition. In another embodiment, the starting fluoropolymer dispersion is free of fluorinated surfactant.

### BACKGROUND OF THE INVENTION

Lithium batteries, including lithium metal batteries, lithium ion batteries, lithium polymer batteries, and lithium ion polymer batteries are finding increased usage due to drive voltages and higher energy densities than those of conventional batteries using aqueous electrolytes (such as Ni-MH batteries). However, most lithium secondary batteries have different safety characteristics depending on several factors. The safety of these batteries is strictly restricted in terms of ignition and combustion. Currently available lithium ion batteries and lithium ion polymer batteries use polyolefin-based separators in order to prevent a short circuit between a cathode and an anode. However, because such polyolefin-based separators have a melting point of 140° C. or less, they can be shrink melted to cause a change in volume when the temperature of a battery is increased by internal and/or external factors, and that may cause a short-circuit. The short circuit can result in accidents such as explosion or fire in a battery caused by emission of electric energy. As a result, it is necessary to provide a separator that does not cause heat shrinking at high temperature.

Polyvinylidene fluoride, because of its excellent electro-chemical resistance and superb adhesion among fluoropolymers, has been found to be a useful for separator coating to be used in non-aqueous electrolytic devices. U.S. Pat. No. 7,662,517 and U.S. Pat. No. 7,704,641, and US 2010/0330268, incorporated herein by reference, describe a PVDF copolymer solution in organic solvents which is used in conjunction with a powdery metal oxide materials in the coating of a polyolefin separator to be used in a non-aqueous-type battery. The separator forms a barrier between the anode and the cathode in the battery. It was found that the bound inorganic particles on the porous organic separator increased the volume of space that a liquid electrolyte infiltrates, resulting in improved ionic conductivity

The role of the organic solvent is generally to dissolve PVDF copolymer in order to provide good adhesion (non-reversible adhesion) between PVDF copolymer and porous separator and also optionally added the powdery particles and porous separator which upon evaporation of the organic solvent is leaving behind a porous coating on the polyolefin separator.

Unfortunately, there are several issues with these organic-solvent based binder compositions. A large amount of solvent is required for traditional coating separator coating process because the solution/slurry exhibits an abnormally high viscosity at higher concentration levels of PVDF (above 10-20 wt %), making the preparation of coating solution/slurry difficult and the suppression of gelation or reducing viscosity of the solution/slurry composition is difficult as well.

Further, the organic-solvent-based solution/slurry presents safety, health and environmental dangers that are not present in an aqueous system. Organic solvents are generally toxic and flammable, volatile in nature, and involve special manufacturing controls to mitigate risk and reduce environmental pollution from the organic solvent. In addition, a large carbon footprint is associated with use of organic solvents that is not environmentally desirable. Further, extra manufacturing steps, costing time, money, and energy are involved to isolate PVDF copolymers formed in an aqueous media, drying the PVDF based polymer to a powder, then dissolving the powder in a solvent.

There is an environmentally-driven, and safety-driven desire to be able to produce an excellent, interconnective well-adhered PVDF-based separator coating, without the massive use of organic solvents.

To effectively employ waterborne slurries in separator coating, it is important to develop proper formulation that are compatible with current manufacturing practices and provide desired properties of the intermediate and final products. Some common criteria include: a) stability of the waterborne fluoropolymer dispersion, having sufficient shelf-life, b) stability of the slurry after formulation and admixing optionally the powdery material, c) appropriate viscosity of the slurry to facilitate good aqueous casting, and d) sufficient adhesion to the separator which is non-reversible after drying, e) and foaming porous coating on polyolefin separator upon drying. Additionally, from a regulatory view, fluoropolymers made without fluorosurfactants are preferred.

Surprisingly, a stable, aqueous fluoropolymer coating composition has been developed, that is useful in coating of porous separators in non-aqueous electrochemical devices. The coating composition contains fluoropolymer and optionally inorganic particles or organic fibers. The separator coated with the aqueous composition of the invention provides many performance, manufacturing and environmental advantages over solvent-based PVDF compositions and solvent:
a) Aqueous PVDF-based compositions are safer to use and process, less hazardous to health, and more environmentally friendly than solvent-based PVDF compositions.
b) Aqueous PVDF dispersions were advantageously synthesized using non-fluorinated surfactant.
c) Aqueous PVDF dispersions can be used as synthesized, without the need for isolating and drying to a powder, or concentration of the latex—saving time and energy.
d) Aqueous PVDF dispersions contain PVDF copolymer particles that can be softened to adhere to metal oxide particles and a polyolefin separator by using fugitive adhesion promoters—resulting in a porous coating on a separator upon drying.
e) The PVDF-based copolymers have advantageously low melting temperature or low to zero crystalline content so that can have lower film forming temperature and/or require less fugitive solvents.

### SUMMARY OF THE INVENTION

The invention relates to a porous separator having directly coated thereon a composition comprising:
a) from 2 to 150 parts fluoropolymer particles having a weight average particle size of less than 500 nm;
b) optionally from 10 to 500 parts of one or more particles;
c) optionally from 0 to 10 parts of one or more thickeners;
d) optionally, one or more pH adjusting agents;
e) from 0 to 10 parts of one or more additives selected from the group consisting of anti-settling agents and surfactants;
f) optionally from 0 to 5 parts of one or more wetting agents;
g) optionally from 0 to 150 parts of one or more fugitive adhesion promoters;
h) 100 parts water;
all parts being parts by weight based on 100 parts by weight of water, and wherein the composition contains no fluorosurfactant.

Preferably the fluoropolymer is a polyvinylidene fluoride-based polymer.

The invention further relates to a method for coating the separator.

The invention further relates to a non-aqueous electrochemical device having the separator of the invention as a barrier between the anode and the cathode.

### BRIEF DESCRIPTION OF THE DRAWINGS

FIGS. 1 and 2 are FTIR spectra of coated and non-coated separators, showing the durability of the separator coatings of the invention.

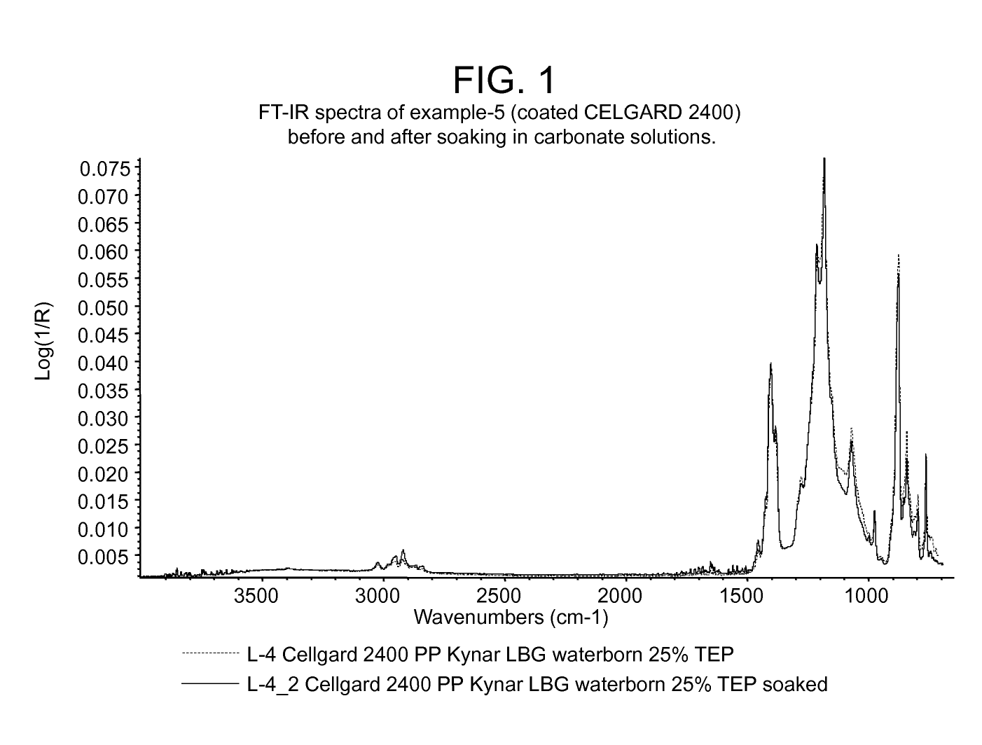

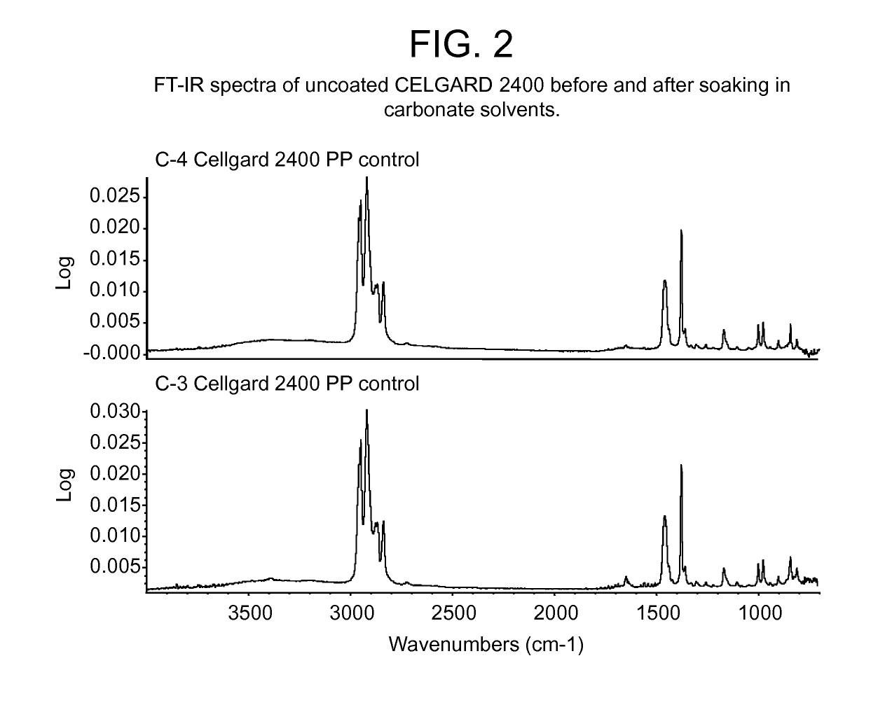

### DETAILED DESCRIPTION OF THE INVENTION

The invention relates to a porous separator coated with an aqueous fluoropolymer-based composition and optionally containing particles, and in particular to a polyvinylidene fluoride-based composition.

By “fluorosurfactant free” is meant that all surfactants used in making the aqueous fluoropolymer dispersion do not contain a fluorine atom (i.e. they are “non-fluorinated surfactants”). The term refers to all surfactants used in making and processing the aqueous fluoropolymer dispersion, and preferably to all the surfactants in the composition of the invention, including: all surfactants used during the polymerization process—whether added up-front, fed continuously during the polymerization, fed partly before and then during polymerization, or fed after the polymerization has started and progressed for a time; and preferably all surfactants added post-polymerization to improve latex stability.

By “irreversible” as used herein in relation to a separator coated by the polymer of the aqueous composition, is meant that following the drying of the aqueous composition in which the polymer adheres to the porous substrate, the polymer coating is not soluble or redispersible in electrolyte solutions, such as carbonates. The irreversibility is due to the fact that the polymer particles flow and adhere to each other, and adhere to the separator and act as a binder for optional powdery inorganic materials, and organic fibers, providing interconnectivity and adhesion.

The manner of practicing the invention will now be generally described with respect to a specific embodiment thereof, namely polyvinylidene fluoride based polymer prepared in aqueous emulsion polymerization using non-fluorinated emulsifier as the principle emulsifier and used in preparation of separators. Although the process of the invention has been generally illustrated with respect to PVDF based polymers and VDF-HPF copolymers, one of skill in the art will recognize that analogous polymerization techniques can be applied to the preparation of other homopolymers and copolymers of fluorinated monomers and their formulation for the coating of separators in general, and more specifically to copolymers of vinylidene fluoride (VDF), tetrafluoroethylene (TFE), and/or chlorotrifluoroethylene (CTFE)—with co-reactive monomers (fluorinated or non-fluorinated) such as hexafluoropropylene, perfluorovinyl ether, propane, vinyl acetate, and the like. While non-fluorinated surfactants are preferred, the use of fluorosurfactants is also anticipated by this invention.

### PVDF

The term “vinylidene fluoride polymer” (PVDF) used herein includes both normally high molecular weight homopolymers, copolymers, and terpolymers within its meaning. Copolymers of PVDF are particularly preferred, as they are softer—having a lower Tm, melting point and a reduced crystalline structure. Such copolymers include those containing at least 50 mole percent, preferably at least 75 mole %, more preferably at least 80 mole %, and even more preferably at least 85 mole % of vinylidene fluoride copolymerized with at least one comonomer selected from the group consisting of tetrafluoroethylene, trifluoroethylene, chlorotrifluoroethylene, hexafluoropropene, vinyl fluoride, pentafluoropropene, tetrafluoropropene, perfluoromethyl vinyl ether, perfluoropropyl vinyl ether and any other monomer that would readily copolymerize with vinylidene fluoride. Particularly preferred are copolymers composed of from at least about 70 and up to 90 mole percent vinylidene fluoride, and correspondingly from 10 to 30 mole percent hexafluoropropene. Terpolymers of vinylidene fluoride, hexafluoropropene and tetrafluoroethylene are also representatives of the class of vinylidene fluoride copolymers, embodied herein.

In one embodiment, up to 20%, and preferably up to 15%, by weight of hexafluoropropene (HFP) units and 80%, preferably 85%, by weight or more of VDF units are present in the vinylidene fluoride polymer. It is desired that the HFP units be distributed as homogeneously as possible to provide PVDF-HFP copolymer with excellent dimensional stability in an end-use environment—such as in a battery.

The copolymer of PVDF for use in the separator coating composition preferably has a high molecular weight. By high molecular weight, as used herein, is meant PVDF having a melt viscosity of greater than 1.0 kilopoise according to ASTM method D-3835 measured at 450° F. and 100 sec⁻¹.

The copolymer of PVDF used in the invention is preferably prepared by aqueous free-radical emulsion polymerization—although suspension, solution and supercritical CO₂ polymerization processes may also be used. In a general emulsion polymerization process, a reactor is charged with deionized water, water-soluble surfactant capable of emulsifying the reactant mass during polymerization and optional paraffin wax antifoulant. The mixture is stirred and deoxygenated. A predetermined amount of chain transfer agent (CTA), is then introduced into the reactor, the reactor temperature raised to the desired level and vinylidene fluoride and one or more comonomers is fed into the reactor. Once the initial charge of monomers are introduced and the pressure in the reactor has reached the desired level, an initiator emulsion or solution is introduced to start the polymerization reaction. The temperature of the reaction can vary depending on the characteristics of the initiator used and one of skill in the art will know how to do so. Typically the temperature will be from about 30° to 150° C., preferably from about 60° to 110° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization can be any surfactant known in the art to be useful in PVDF emulsion polymerization, including perfluorinated, partially fluorinated, and non-fluorinated surfactants. Preferably, for regulatory reasons, the PVDF emulsion of the invention is made without fluorinated surfactants. Non-fluorinated surfactants useful in the PVDF polymerization could be both ionic and non-ionic in nature including, but are not limited to, 3-allyloxy-2-hydroxy-1-propane sulfonic acid salts, polyvinylphosphonic acid, polyacrylic acids, polyvinyl sulfonic acid, and salts thereof, polyethylene glycol and/or polypropylene glycol and the block copolymers thereof, alkyl phosphonates and siloxane-based surfactants.

The PVDF polymerization results in a latex generally having a solids level of 10 to 60 percent by weight, preferably 10 to 50 percent, and having a weight average particle size of less than 500 nm, preferably less than 400 nm, and more preferably less than 300 nm. The weight average particle size is generally at least 20 nm and preferably at least 50 nm. The composition of the invention contains 2 to 150 parts by weight of PVDF copolymer binder particles per 100 parts of water, preferably 1 to 25 parts by weight. Additional adhesion promoters may also be added to improve the binding characteristics and provide connectivity and adhesion that is non-reversible. A minor amount of one or more other water-miscible solvents, such as ethylene glycol, may be mixed into the PVDF latex to improve freeze-thaw stability.

In the present invention, PVDF based-polymer binder is generally used in the coating composition, however a blend of several different polymer binders, preferably all fluoropolymer binders, and most preferably all PVDF binders may also be used. In one embodiment, only thermoplastic fluoropolymers that can be softened by fugitive adhesion promoters are used as the polymeric coating/binder.

### Powdery Particles

The powdery particular materials, or powdery particle in the coating composition permit an interstitial volume to be formed among them, thereby serving to form micropores and to maintain the physical shape as spacer. Additionally, because the powdery particles are characterized in that their physical properties are not changed even at a high temperature of 200° C. or higher, the coated separator using the inorganic particles can have excellent heat resistance. The powdery particles may be inorganic, organic, and may be in the form of particles or fibers. Mixtures of these are also anticipated.

The powdery particular materials, must be electrochemically stable (not subjected to oxidation and/or reduction at the range of drive voltages). Moreover, the powdery materials preferably have a high ion conductivity. Materials of low density are preferred over higher density materials, as the weight of the battery produced can be reduced. The dielectric constant is preferably 5 or greater. Useful inorganic powdery materials in the invention include, but are not limited to BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO(HfO₂), SrTiO₃, SnO₂, CeO₂, MgO, NiO, CaO, ZnO, Y₂O₃, Al₂O₃, TiO₂, SiC, ZrO₂, boron silicate, BaSO₄, nano-clays, ceramics, or mixtures thereof. Useful organic fibers, include, but are not limited to aramid fillers and fibers, polyetherether ketone and polyetherketone ketone fibers, PTFE fibers, and nanofibers.

In one embodiment, the particles or fibers may be surface treated, chemically (such as by etching or functionalization), mechanically, or by irradiation (such as by plasma treatment).

The separator of the invention can form pores having a size from several nanometers up to several micrometers by controlling the size of the powdery materials, content of inorganic materials and the mixing ratio of inorganic materials and binder polymer. It is also possible to control the pore size and porosity.

The powdery materials preferably have an average diameter of 0.001-10 microns. Preferably fibers have diameters below 1 micron, and fiber overlap does not amount to more than about 4-5 microns in thickness. When the size is less than 0.001 micron the particles have poor dispersibility. When the size is greater than 10 micron the coating has an increased thickness under the same solid content, resulting in degradation in mechanical properties. Furthermore, such excessively large pores may increase a possibility of internal short circuit being generated during repeated charge/discharge cycles.

The powdery materials are present in coating composition at 50 to 99 weight percent, preferably 60-95 weight percent, based on the total of polymer solids and powdery material. When the content of the inorganic materials is less than 50 weight percent, the PVDF binder polymer is present in such a large amount as to decrease the interstitial volume formed among the powdery particles and thus to decrease the pore size and porosity, resulting in degradation in the quality of a battery. In order to avoid this problem, the total solid content of aqueous dispersion can be adjusted to a lower level. When the content of the powdery materials is greater than 99 weight percent, the polymer content is too low to provide sufficient adhesion among the particles, resulting in degradation in mechanical properties of a finally formed coated separator.

### Surfactant/Anti-Settling Agent

The coating composition of the invention contains 0 to 10 parts, preferably from 0.1 to 10 parts, and more preferably 0.5 to 5 parts of one or more anti-settling agents and/or surfactants per 100 parts of water. In one embodiment the level of anti-settling agent or surfactant is from 2.7 to 10 parts per 100 parts of water. These anti-settling agents or surfactants are added to the PVDF dispersion post-polymerization, generally to improve the shelf stability, and provide additional stabilization during slurry preparation. Also during the polymerization process, the surfactant/anti-settling agent used in this invention could be added all upfront prior to polymerization, fed continuously during the polymerization, fed partly before and then during polymerization, or fed after polymerization started and progressed for a while.

Useful anti-settling agents include, but are not limited to, ionic substances, such as salts of alkyl sulfates, sulfonates, phosphates, phophonates (such as sodium lauryl sulfate and ammonium lauryl sulfate) and salts of partially fluorinated alkyl sulfates, carboxylates, phosphates, phosphonates (such as those sold under the CAPSTONE brandname by DuPont), and non-ionic surfactants such as the TRITON X series (from Dow) and PLURONIC series (from BASF). In one embodiment, only anionic surfactants are used. It is preferred that no fluorinated surfactants are present in the composition, either residual surfactant from the polymerization process, or added post-polymerization in forming or concentrating an aqueous dispersion.

### Wetting Agent

The coating composition of the invention optionally contains 0 to 5 parts, preferably from 0 to 3 parts of one or more wetting agents per 100 parts of water. Surfactants can serve as wetting agents, but wetting agents may also include non-surfactants. In some embodiments, the wetting agent can be an organic solvent. The presence of optional wetting agents permits uniform dispersion of powdery material(s) into aqueous dispersion of vinylidene fluoride polymer. Useful wetting agents include, but are not limited to, ionic and non-ionic surfactants such as the TRITON series (from Dow) and the PLURONIC series (from BASF), BYK-346 (from BYK Additives) and organic liquids that are compatible with the aqueous dispersion, including but not limited to NMP, DMSO, and acetone.

### Thickener/Rheology Modifier

The coating composition of the invention may contain 0 to 10 parts, preferably from 0 to 5 parts of one or more thickeners or rheology modifiers per 100 parts of water. Addition of water-soluble thickener or rheology modifier to the above dispersion prevents or slows down the settling of powdery materials while providing appropriate slurry viscosity for a casting process. Useful thickeners include, but are not limited to the ACRYSOL series (from Dow Chemical); partially neutralized poly(acrylic acid) or poly(methacrylic acid) such as CARBOPOL from Lubrizol; and carboxylated alkyl cellulose, such as carboxylated methyl cellulose (CMC). Adjustment of the formulation pH can improve the effectiveness of some of the thickeners. In addition to organic rheology modifiers, inorganic rheology modifiers can also be used alone or in combination. Useful inorganic rheology modifiers include, but are not limited to, inorganic rheology modifiers including but not limited to natural clays such as montmorillonite and bentonite, manmade clays such as laponite, and others such as silica, and talc.

The thickeners are used in the aqueous composition containing the PVDF and powdery material, and are not used in pure form as a second coating composition as has been described in the JP 2000357505 reference.

### Fugitive Adhesion Promoter

A fugitive adhesion promoter is preferably present to produce the adhesion needed in coatings formed from the composition of the invention. By “fugitive adhesion promoter”, as used herein, is meant an agent that increases the adhesion of the composition after coating on the porous substrate. The fugitive adhesion promoter is then capable of being removed from the formed substrate generally by evaporation (for a chemical) or by dissipation (for added energy).

The fugitive adhesion promoter can be a chemical material, an energy source combined with pressure, or a combination, used at an effective amount to cause interconnectivity of the components of the aqueous composition during coating formation. For chemical fugitive adhesion promoters, the composition contains 0 to 150 parts, preferably 1 to 100 parts, and more preferably from 2 to 30 parts, of one or more fugitive adhesion promoters per 100 parts of water. Preferably this is an organic liquid, that is soluble or miscible in water. This organic liquid acts as a plasticizer for PVDF particles, making them tacky and capable of acting as discrete adhesion points during the drying step. The PVDF polymer particles are able to soften, flow and adhere to separator and optionally the powdery materials during manufacture, resulting in separator coatings with high adhesion and connectivity that are non-reversible. In one embodiment the organic liquid is a latent solvent, which is a solvent that does not dissolve or substantially swell PVDF resin at room temperature, but will solvate the PVDF resin at elevated temperatures. In one embodiment a useful organic solvent is N-methyl-2-pyrrolidone. Other useful fugitive adhesion promoter agents include, but are not limited to, dimethylformamide, N,N-dimethylacetamide, dimethylsulfoxide (DMSO), hexamethylphosphamide, dioxane, tetrahydrofuran, tetramethylurea, triethyl phosphate, trimethyl phosphate, dimethyl succinate, diethyl succinate and tetraethyl urea.

In the case of energy as the fugitive adhesion promoter, useful energy sources include, but are not limited to, heat, IR radiation, and radio frequency (RF). For heat alone, the temperature during the processing of the PVDF copolymer composition on an electrode should be close to the melting point of the polymer.

### Other Additives.

The coating composition of the invention may further contain effective amounts of other additives, including but not limited to fillers, leveling agents, anti-foaming agents, pH buffers, and other adjutants typically used in waterborne formulation while meeting desired electrode requirements.

The aqueous coating composition of the invention can be obtained in many different ways.

In one embodiment, a PVDF formulation is formed (preferably without any fluorosurfactant) and a predetermined amount of any anti-settling agent(s) or surfactant(s), is diluted in water and post-added to the PVDF dispersion latex with stirring, in order to provide adequate storage stability for the latex. To this PVDF dispersion/anti-settling mixture is added, with stirring, optional wetting agent(s), followed by adding any thickener(s), fugitive adhesion promoter(s), and then bringing the pH up to the appropriate range for the thickener to be effective, if necessary. Some thickeners such as CMC are effective in a wide range of pH, i.e. from 3 to 9 pH for CMC. The powdery material(s) and other ingredients are then added to the mixture. It may be advantageous to disperse the powdery material(s) in the fugitive adhesion promoter, the latent solvent or wetting agent to provide wetting of the materials prior to admixing with the aqueous PVDF binder formulation.

There is no particular limitation in choosing the substrate that is coated with the aqueous coating composition of the invention, as long as it is a porous substrate having pores. Preferably the substrate is a heat resistant porous substrate having a melting point of greater than 200° C. Such heat resistant porous substrates can improve the thermal safety of the coated separator under external and/or internal thermal impacts.

Examples of porous substrates useful in the invention as the separator include, but are not limited to: polyolefins, polyethylene terephthalate, polybutylene terephthalate, polyester, polyacetal, polyamide, polycarbonate, polyimide, polyetherether ketone, polyether sulfone, polyphenylene oxide, polyphenylene sulfidro, polyethylene naphthalene or mixtures thereof. However, other heat resistant engineering plastics may be used with no particular limitation. Non-woven materials of natural and synthetic materials may also be used as the substrate of the separator.

The porous substrate generally has a thickness of from 1 micron to 50 microns, and are typically cast membranes of non-wovens. The porous substrate preferably has a porosity of between 5% and 95%. The pore size (diameter) preferably ranges from 0.001 micron to 50 micron, more preferably from 0.01 micron to 10 micron. When the pore size and porosity are less than 0.01 micron and 5%, respectively, the porous substrate may function as resistance layer. When the pore size and porosity are greater than 50 micron and 95%, respectively, it is difficult to maintain mechanical properties.

The porous substrate may take the form of a membrane, or fibrous web. When the porous substrate is fibrous, it may be a nonwoven web forming a porous web, such as a spunbond or melt blown web.

An alternative method is to use a fluoropolymer powder, that is redispersed in water for form a fluoropolymer dispersion. In this case the particles will have been agglomerated, and the agglomerated particle size will be greater than 500 nm.

The aqueous coating composition is applied onto at least one surface, and preferably both face surfaces, of an porous substrate by means known in the art, such as by brush, roller, ink jet, squeegee, foam applicator, curtain coating, vacuum coating, or spraying. The coating is then dried onto the separator. The final dry coating thickness is from 0.5 to 15 microns, preferably from 1 to 8 microns, and more preferably from 2 to 4 microns in thickness.

In one embodiment, the fluoropolymer coating may further be cross-linked to control swelling and dissolution. Useful crosslinking mechanisms include chemical crosslinking, and crosslinking by irradiation, and in particular by e-beam, UV radiation, LED radiation, and gamma irradiation.

The separators of the invention can be used to form an electrochemical device, such as a battery, capacitor, electric double layer capacitor, membrane electrode assembly (MEA) or fuel cell, by means known in the art. A non-aqueous-type battery can be formed by placing a negative electrode and positive electrode on either side of the coated separator.

### EXAMPLES

### General

The latexes of the invention are prepared by a typical process for making fluoropolymers using emulsifiers. The emulsifiers may be ionic or non-ionic, such as those containing blocks of polyethylene glycol, polypropylene glycol and/or polytetramethylene glycol. Preferably, the process and fluoropolymer produced contain no fluorinated or partially fluorinated surfactant. The fluoropolymer dispersions produced have good latex stability and shelf-life, and are coagulum-free. These preferred dispersions are absolutely free of fluorinated or partially fluorinated surfactant—with no fluorinated surfactant being used in either the synthesis or in a post-addition.

In the polymerization process, the emulsifier may be added all upfront prior to polymerization, fed continuously during the polymerization, fed partly before and then during polymerization, or fed after polymerization started and progressed for a while.

### Example 1

Into an 80-gallon stainless steel reactor was charged, 345 lbs of deionized water, 250 grams of PLURONIC 31R1 (non-fluorinated non-ionic surfactant from BASF), and 0.3 lbs of propane. Following evacuation, agitation was begun at 23 rpm and the reactor was heated. After reactor temperature reached the desired set point of 100° C., the VDF charge was started. Reactor pressure was then raised to 650 psi by charging approximately 35 lbs VDF into the reactor. After reactor pressure was stabilized, 4.5 lbs of initiator solution made of 1.0 wt % potassium persulfate and 1.0 wt % sodium acetate was added to the reactor to initiate polymerization. The rate of further addition of the initiator solution was adjusted to obtain and maintain a final VDF polymerization rate of roughly 70 pounds per hour. The VDF homopolymerization was continued until approximately 150 pounds VDF was introduced in the reaction mass. The VDF feed was stopped and the batch was allowed to react-out at the reaction temperature to consume residual monomer at decreasing pressure. After 25 minutes, the agitation was stopped and the reactor was cooled, vented and the latex recovered. Solids in the recovered latex were determined by gravimetric technique and were about 27 weight % and melt viscosity of about 27 kp according to ASTM method D-3835 measured at 450° F. and 100 sec⁻¹. The melting temperature of resin was measured in accordance with ASTM method D-3418 and was found to be about 162° C. The weight average particle size was measured by NICOMP laser light scattering instrument and was found to be about 150 nm.

### Examples 2

Into an 80-gallon stainless steel reactor was charged, 345 lbs of deionized water, 250 grams of PLURONIC 31R1 (non-fluorinated non-ionic surfactant from BASF), and 0.6 lbs of ethyl acetate. Following evacuation, agitation was begun at 23 rpm and the reactor was heated. After reactor temperature reached the desired set point of 100° C., the VDF and HFP monomer were introduced to reactor with HFP ratio of 40 wt % of total monomers. Reactor pressure was then raised to 650 psi by charging approximately 35 lbs total monomers into the reactor. After reactor pressure was stabilized, 5.0 lbs of initiator solution made of 1.0 wt % potassium persulfate and 1.0 wt % sodium acetate were added to the reactor to initiate polymerization. Upon initiation, the ratio of HFP to VDF was so adjusted to arrive at 16.5% HFP to total monomers in the feed. The rate of further addition of the initiator solution was also adjusted to obtain and maintain a final combined VDF and HFP polymerization rate of roughly 70 pounds per hour. The VDF and HPF copolymerization was continued until approximately 160 pounds monomers were introduced in the reaction mass. The HFP feed was stopped but VDF feed continued till approximately 180 lbs of total monomers were fed to the reactor. The VDF feed was stopped and the batch was allowed to react-out at the reaction temperature to consume residual monomer at decreasing pressure. After 40 minutes, the initiator feed and agitation were stopped and the reactor was cooled, vented and the latex recovered. Solids in the recovered latex were determined by gravimetric technique and were about 32 weight % and melt viscosity of about 28 kp according to ASTM method D-3835 measured at 450° F. and 100 sec⁻¹. The melting temperature of resin was measured in accordance with ASTMD3418 and was found to be about 120° C. The weight average particle size was measured by NICOMP laser light scattering instrument and was found to be about 160 nm.

### Examples 3

Into an 80-gallon stainless steel reactor was charged, 345 lbs of deionized water, 250 grams of PLURONIC 31R1 (non-fluorinated non-ionic surfactant from BASF), and 0.35 lbs of ethyl acetate. Following evacuation, agitation was begun at 23 rpm and the reactor was heated. After reactor temperature reached the desired set point of 100° C., the VDF and HFP monomer were introduced to reactor with HFP ratio of 13.2 wt % of total monomers. Reactor pressure was then raised to 650 psi by charging approximately 35 lbs total monomers into the reactor. After reactor pressure was stabilized, 3.5 lbs of initiator solution made of 1.0 wt % potassium persulfate and 1.0 wt % sodium acetate were added to the reactor to initiate polymerization. Upon initiation, the ratio of HFP to VDF was so adjusted to arrive at 4.4% HFP to total monomers in the feed. The rate of further addition of the initiator solution was also adjusted to obtain and maintain a final combined VDF and HFP polymerization rate of roughly 90 pounds per hour. The VDF and HPF copolymerization was continued until approximately 160 pounds monomers were introduced in the reaction mass. The HFP feed was stopped but VDF feed continued till approximately 180 lbs of total monomers were fed to the reactor. The VDF feed was stopped and the batch was allowed to react-out at the reaction temperature to consume residual monomer at decreasing pressure. After 40 minutes, the initiator feed and agitation were stopped and the reactor was cooled, vented and the latex recovered. Solids in the recovered latex were determined by gravimetric technique and were about 32 weight % and melt viscosity of about 38 kp according to ASTM method D-3835 measured at 450° F. and 100 sec⁻¹. The melting temperature of resin was measured in accordance with ASTM method D-3418 and was found to be about 152° C. The weight average particle size was measured by NICOMP laser light scattering instrument and was found to be about 160 nm.

The above PVDF based latexes of example 1-3 were then formulated into an aqueous separator coating composition and applied to a separator and dried.

### Example 4-6

Aqueous separator coating compositions were prepared by making first, stock solution of A comprised 1.5% BYK-346 (from BYK-Chemie) in DI water; second stock solution B comprised of 50-50 mixture of tri-ethyl-phosphate (TEP) and stock solution A. Then stock solutions A and B were added to 50 g plus 0.5 g BYK-346 latex of Example-3 as tabulated in Table-1.

TABLE 1
Aqueous separator coating compositions

| | Solution A | Solution B | BYK-346 |
|---|---|---|---|
| Sample | (g) | (g) | (g) |
| 4 | 85 | 20 | 0.5 |
| 5 | 80 | 25 | 0.5 |
| 6 | 55 | 50 | 0.5 |

### Example 7-9

Aqueous separator coating compositions were prepared by using stock solutions and BYK-346 provided above and adding them to 50 g latex of Example-2 as shown in Table-2.

TABLE 2
Aqueous separator coating compositions

| | Solution A | Solution B | BYK-346 |
|---|---|---|---|
| Sample | (g) | (g) | (g) |
| 7 | 90 | 15 | 0.5 |
| 8 | 80 | 25 | 0.5 |
| 9 | 55 | 50 | 0.5 |

### Example 10-11

Aqueous separator coating compositions were prepared by using stock solutions provided above and adding them to 50 g latex of Example-1 according to Table-3.

TABLE 3
Aqueous separator coating compositions

| | Solution A | Solution B | BYK-346 |
|---|---|---|---|
| Sample | (g) | (g) | (g) |
| 10 | 80 | 25 | 0.5 |
| 11 | 55 | 50 | 0.5 |

### Film Forming Evaluation:

The quality of film formation was evaluated by placing 10 g of each of aqueous separator coating compositions and comparative examples in a convection oven for 4 hrs at 80° C. The dried resins from examples 4 to 11 were well fused and made nice continuous film without any cracks.

Furthermore, samples of polyolefin separator, M 2400 by CELGARD (25 micrometer thick polypropylene film with 43 nm average pore diameter) were submerge into aqueous separator coating compositions of examples 4-11 and dried in convection oven at 80° C. FTIR analysis of sample surfaces indicated that good uniform film of at least 3 micron thick of PVDF-based polymer of examples 1-3 were deposited onto polyolefin separator.

Coated samples of 7-9 were soaked in carbonate solution comprised EC/DMC/DEC of equal ratios for 4 hr at room temperature and dried in an oven for 8 hr. FTIR analysis indicated that the PVDF-based film on separators of sample 7-9 did not washed off after soaking in carbonate solvents.

1. A porous separator having directly coated thereon a dried coating composition comprising:
a) from 2 to 150 parts fluoropolymer particles having a weight average particle size of less than 500 nm;
b) optionally from 10 to 500 parts of one or more powdery particles;
c) optionally from 0 to 10 parts of one or more thickeners;
d) optionally, one or more pH adjusting agents;
e) from 0 to 10 parts of one or more additives selected from the group consisting of anti-settling agents and surfactants;
f) optionally from 0 to 5 parts of one or more wetting agents;
g) optionally from 0 to 150 parts of one or more fugitive adhesion promoters;
h) 100 parts water;
all parts being parts by weight based on 100 parts by weight of water, and wherein the composition contains no fluorosurfactant.

2. The porous separator of claim 1, wherein said fluoropolymer is a polyvinylidene fluoride (PVDF) copolymer comprising at least 70 mole percent of vinylidene fluoride units.

3. The porous separator of claim 1, Wherein said coating composition comprises from 10 to 500 parts of one or more powdery particles.

4. The porous separator of claim 1, wherein the fluoropolymer particles have a weight average particle size less than 400 microns.

5. The porous separator of claim 1, wherein said powdery inorganic material comprises one or more materials selected from the group consisting of BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO(HfO₂), SrTiO₃; SnO₂, CeO₂, MgO, NiO, CaO, ZnO, Y₂O₃, Al₂O₃, TiO₂, SiC, ZrO₂, boron silicate, BaSO₄, nano-clays, ceramics, aramid fillers and fibers, polyetherether ketone fibers, polyetherketone ketone fibers, PTFE, fibers and nanofibers or mixtures thereof.

6. The porous separator of claim 1, wherein said fugitive adhesion promoter is selected from the group consisting of N-methyl-2-pyrrolidone, dimethylformamide, N,N-dimethylacetamide, dimethylsulfoxide, hexamethylphosphamide, dioxane, tetrahydrofuran, tetramethylurea, triethyl phosphate, trimethyl phosphate, dimethyl succinate, diethyl succinate and tetraethyl urea and mixtures thereof.

7. The porous separator of claim 1, wherein said dry coating thickness is in the range of from 1 to 8 microns.

8. The porous separator of claim 1, wherein said porous separator is a membrane, or fibrous web selected from the group consisting of polyolefins, polytetrafluoroethylene, polyethylene terephthalate, polybutylene terephthalate, polyester, polyacetal, polyamide, polycarbonate, polyimide, polyetherether ketone, polyether sulfone, polyphenylene oxide, polyphenylene sulfidro, and polyethylene naphthalene.

9. The porous separator of claim 1, wherein said porous separator is a cast membrane formed by a cast process, or a non-woven.

10. An electrochemical device comprising the coated separator of claim 1.

11. The electrochemical device of claim 10, wherein said device is selected from the group consisting of a non-aqueous-type battery, a capacitor, and a membrane electrode assembly.
